(19) United States
(12) Patent Application Publication
(10) Pub. No.: US 2025/0354004 A1
(43) Pub. Date: Nov. 20, 2025

(54) LOW TEMPERATURE CURING COMPOSITON FOR RUBBER BASED ADHESIVES AND SEALANTS

(71) Applicant: Henkel AG & Co. KGaA, Duesseldorf (DE)

(72) Inventors: Paul D. Zeits, Rochester, MI (US); Gail M. Henning, Troy, MI (US); Erica Elizabeth Gibbons, Clay, MI (US)

(21) Appl. No.: 19/289,545

(22) Filed: Aug. 4, 2025

Related U.S. Application Data
(63) Continuation of application No. PCT/US2024/013999, filed on Feb. 1, 2024.
(60) Provisional application No. 63/486,516, filed on Feb. 23, 2023.

(51) Int. Cl. C08L 51/04; C08J 9/06; C08J 9/14; C08K 3/22; C08K 3/26; C08K 3/36; C08K 5/14; C08K 5/21; C08K 5/33; C09J 5/00; C09J 151/04

(52) U.S. Cl. CPC C08L 51/04; C08J 9/06; C08J 9/14; C08K 3/22; C08K 3/36; C08K 5/14; C08K 5/21; C08K 5/33; C09J 5/00; C09J 151/04; C08J 2207/02; C08J 2351/04; C08K 2003/2206; C08K 2003/2227; C08K 2003/265; C08L 2205/025; C08L 2205/035; C08L 2205/06; C08L 2207/322

(57) ABSTRACT

The invention relates to a rubber-based composition that can be thermally cured at reduced temperature while retaining performance over a broad cure temperature window comprising at least one solid rubber, at least one diene-based polymer or copolymer containing an olefinic double bond and/or an aromatically substituted olefin, suitable for undergoing curing with a curing system present as quinone dioxime, peroxides and optional multifunctional acrylates, preferably in the absence of elemental sulfur. The cured composition exhibits improved reversion resistance and adhesion strength on aluminum.

### TECHNICAL FIELD

The present invention relates to a thermally curable rubber-based composition, useful in adhesives and/or sealants; to a cured product thereof; and to methods of making and using same.

### BACKGROUND

With the advent of low temperature curing of electrocoating (e-coat) paints, adhesives and sealants co-cured with these paints are needed that achieve performance under the same conditions. The typical cure temperature range of automotive adhesives and sealants is 160° C. to 200° C., and newer electrocoating paints target curing at lower temperatures as low as 140° C.

Attempts have been made to produce adhesives and sealants with reduced cure temperatures for curing with paint in various manufacturing applications, but only partial success has been achieved. It has been suggested that rubber-based compositions may be cured at temperatures as low as 120° C. by extending cure time to 150 min. (2½ hours). However, this extended cure time is not usable in most line assembly processes, including e-coat which passes coated parts through bake ovens in about 10-20 minutes. Thus there is a need for low temperature curing rubber-based adhesive and sealant compositions curable at about 140° C. or below and a cure time in a range of 5 min. to about 25 min.

Accelerated curing systems can achieve curing below 160° C., but revealed poor storage stability limiting shelf-life. They are also sensitive to overbaking (such as during a line stoppage) showing substantial degradation at higher temperatures of greater than 200° C. One part systems have relied on encapsulation methods to maintain shelf-life introducing cost and complexity of manufacture. Other previous low temperature compositions have been two part systems which are inconvenient and introduce risk of premature cure, poor wet out or contamination of the open bead surface of the adhesive if stored. Thus there is a need for low temperature curing rubber-based adhesive and sealant compositions having good storage stability.

A thermally curable rubber-based composition is usually heated at a temperature in the range of about 160 to 180° C. for curing using an oven or the like. However, there are some cases where the temperature in the oven increases to higher temperature (for example, 190° C. or higher), and thus the thermally curable composition is exposed to the state of the so-called overbaking. Accordingly, it is an object of the present invention to provide a thermally curable composition having excellent adhesion to metal substrates, in particular aluminum, exhibiting substantially uniform curing characteristics at oven temperatures ranging from 130° C. to 200° C. and exhibiting a small decrease in strength even if heated at temperature of 190° C. or greater (referred to herein as reversion resistance).

In vehicle construction, one use of thermally cured rubber-based adhesive and sealant compositions includes so-called underlays applied between the body in white outer shell and corresponding structural materials found in, for example, roof arches, rocker panels, security elements or strengthening elements. The underlay can strengthen the vehicle structure, and serve adhesive, acoustic and/or sealing functions.

Growth of the electric vehicle (EV) market introduced new challenges to the traditional curing window for adhesives and sealants. In particular, a substantial amount of reinforcement has been added to the lower rocker panels of many electric vehicles to protect the battery system. This additional mass requires more thermal energy to increase the mass' temperature, creating a heat sink, which prevents the body in white from reaching a uniform cure temperature for adhesive and sealant cure during the e-coat curing process. This non-uniform body temperature results in underbake of large masses and/or overbake of thinner structures such as roofs. Thus there is a need for low temperature curing rubber-based compositions which retain strength despite cure at temperatures of about 190-230° C.

It is an object of the invention to solve one or more of the above described disadvantages.

### SUMMARY OF INVENTION

The present invention relates to a thermally curable, rubber-based composition curable at reduced temperatures of about 130° C.-140° C.; a cured composition adhered to a metal surface; an adhesive, sealant or acoustic attenuating product thereof exhibiting one or more of improved resistance to reversion, e.g. reduced decrease in strength after high temperature heating, excellent adhesion to aluminum; and a product, component or assembly made with the composition or comprising the cured composition methods of making and using the foregoing.

The present invention cures at significantly lower temperatures of about 130° C.-140° C. in cure times of about 10-20 minutes, while being substantially reversion resistant to high cure temperatures of about 190-230° C. This feature enables use of the composition in body in white areas that reach high temperature (e.g. roofs) and low temperature (e.g. large mass areas such as reinforced body portions) during cure.

The thermally curable composition comprises a low temperature curing system, preferably free or substantially free from sulfur, and comprising two or more of quinone dioxime; peroxide, and a multifunctional coagent, such as (meth)acrylate monomer, oligomer or polyol. While traditional accelerators, such as organic accelerators and/or metal oxide(s), different from the peroxides and unsaturated coagents disclosed herein, may be included, amounts are preferably minimized and in some embodiments are absent. For example, dithiocarbamates (in the form of their ammonium or metal salts), xanthogenates, thiuram compounds (monosulfides and disulfides), thiazole compounds, aldehyde/amine accelerators (e.g. hexamethylenetetramine), dibenzothiazyl disulfide (MBTS), 2-mercaptobenzthiazole (MBT), its zinc salt (ZMBT), zinc dibenzyldithiocarbamate (ZBEC), N-cyclohexylbenzodithiazyl sulfonamide (CBS).

In one aspect of the invention, the composition may be comprised of natural and synthetic rubbers containing olefinic unsaturation suitable for undergoing curing with a system containing at least two of: quinone dioxime, peroxide, a multifunctional coagent comprising a plurality of α,β-unsaturated carbonyl functional groups.

The compositions may additionally comprise processing oils/plasticizers and fillers to promote pumpable characteristics and/or sag resistance in the uncured composition as well as antioxidant, colorant or dye, adhesion promoters, hydrocarbon resin different from the diene based components and rheology modifiers.

Various aspects of the present invention may be summarized as follows:

Aspect 1: A thermally curable composition, comprising:

a component (a) comprising:
(a1) a solid rubber;
(a2) an olefinic double bond-containing polymer which is liquid or pasty at 22° C.;
(a3) a processing oil; and
(a4) a liquid polydiene;
   and
   a component (b) a curing system comprising two or more of:
(b1) quinone dioxime;
(b2) an organic peroxide and
(b3) a multifunctional coagent comprising a plurality of α,β-unsaturated carbonyl functional groups.

Aspect 2.: The thermally curable composition according to Aspect 1, further comprising a component (c) comprising:
(c1) a physical blowing agent in an amount of 0 to 3 wt. % based on the total weight of the composition;
(c2) a chemical blowing agent in an amount of 0 to 4.0 wt. % based on the total weight of the composition; and
(c3) a urea-based blowing agent accelerator in an amount of 0 to 1 wt. %.

Aspect 3. The thermally curable composition according to any of the foregoing Aspects, wherein the curing system (b) is:
(b2) the organic peroxide present in an amount of 0.2 to 2.0%, based on the total weight of the composition; and
(b3) the multifunctional coagent is present in an amount of 0.3 to 7 wt. %, based on the total weight of the composition.

Aspect 4. The thermally curable composition according to any of the foregoing Aspects, wherein the amount of (c1), (c2) and (c3) is 0 wt. % based on the total weight of the composition.

Aspect 5. The thermally curable composition according to any of the foregoing Aspects, wherein the olefinic double bond-containing polymer (a2) comprises a polybutadiene grafted with about maleic anhydride and has a mass average molecular weight of between 10,000 and 750 Daltons.

Aspect 6. The thermally curable composition according to any of the foregoing Aspects, wherein the polybutadiene grafted with maleic anhydride (a2) comprises 4 to 20 pbw maleic anhydride moieties.

Aspect 7. The thermally curable composition according to any of the foregoing Aspects, wherein (a3) the processing oil comprises paraffin oil in an amount of 5 wt. % to 30 wt. %, based on the total mass of the composition.

Aspect 8. The thermally curable composition according to any of the foregoing Aspects, wherein (a4) the liquid polydiene different from (a1-a3) is a polybutadiene polymer having mass average molecular weight of 1000-50,000 g/mol.

Aspect 9 The thermally curable composition according to any of the foregoing Aspects, wherein (b3) the multifunctional coagent comprising a monomer, oligomer or polymer having a plurality of α,β-unsaturated carbonyl functional groups includes at least one tri-functional (meth)acrylate.

Aspect 10. The thermally curable composition according to any of the foregoing Aspects, wherein:
(a1) the solid rubber is present in an amount of about 8 to 20 wt. % based on total weight of the composition;
(a2) the olefinic double bond-containing polymer which is liquid or pasty at 22° C., is present in an amount of about 5 to 15 wt. % based on the total weight of the composition;
(a3) the processing oil is present in an amount of about 5 to 30 wt. % based on the total weight of the composition;
(a4) the liquid polydiene, different from (a1)-(a3) present in an amount of about 3 to 20 wt. % based on the total weight of the composition;
(b1) the quinone dioxime is present in an amount of 0.1 to 5 wt. % based on the total weight of the composition;
(b2) the organic curing agent is an organic peroxide, present in an amount of 0.05 to 5.0%, based on the total weight of the composition; and
(b3) the multifunctional coagent is present in an amount of 0.1 to 10 wt. %, based on the total weight of the composition; and
the thermally curable composition further comprises as additional components:
   calcium oxide present in an amount of 0.1-6 wt. %; and
   filler present in a total amount of 10 to 50 wt. %;
all wt. % amounts based on the total mass of the composition; and
   wherein the components are selected such that the thermally curable composition has a viscosity such that said composition is pumpable with a pump at a temperature in a range of 15 to 60° C.

Aspect 11. The thermally curable composition according to any of the foregoing Aspects, further comprising a filler (d) in an amount of 10 wt. % to 45 wt. %, based on the total weight of the composition.

Aspect 12. An article of manufacture comprising a component comprising a metal surface, preferably an aluminum surface and adhered to said metal surface is the composition according to any of the foregoing Aspects, as-cured at a temperature in a range of 120 to 140° C. for a time in a range of 10 to 20 min. thereby forming an adhesive bond between two parts of the article and/or sealing surfaces of the article wherein the article of manufacture is a component of a vehicle, apparatus, tool or aircraft.

Aspect 13. A process for applying an adhesive or sealant to a metal substrate having at least one aluminum metal surface, comprising steps of:
delivering the composition according to any of the foregoing Aspects at a temperature in a range of 15 to 60° C., preferably by a pump, to a point of application;
depositing the composition in a liquid or pasty state onto a selected region of a first aluminum metal surface of the substrate;
optionally bringing a second metal substrate into contact with the selected region bearing the composition; and
   subsequently heating the composition at a temperature in a range of 130 to 220° C., for a time sufficient to thereby form a cured composition bonded to the aluminum metal surface;
   wherein Lap Shear Strength bond strength of the composition cured at 220° C. is at least 80, 85 or 90% of the bond strength of the composition cured at 130° C.

Aspect 14. The process of Aspect 13, further comprising a step of thermal curing, and optional foaming, by heating the composition to a temperature in a range of 120-140° C. and maintaining said temperature range for a period of 10 to 60 minutes.

For a variety of reasons, it is preferred that compositions according to the invention, whether a single component composition (1K) or a multiple part composition, e.g. separately packaged Part A and Part B, as defined above, may be substantially free from many ingredients used in compositions for similar purposes in the prior art. Specifically, it is increasingly preferred in the order given, independently for each preferably minimized ingredient listed below, that adhesive compositions according to the invention, when directly contacted with metal in a process according to this invention, contain no more than 1.0, 0.5, 0.35, 0.10, 0.08, 0.04, 0.02, 0.01, 0.001, or 0.0002 percent, more preferably said numerical values in grams per liter, more preferably in ppm, of each of the following constituents: epoxy resin or polymer, organic filler, thickener, chromium, nitrite ions, formaldehyde, formamide, hydroxylamines, ammonia; rare earth metals; elemental sulfur and/or compounds thereof; permanganate; chlorites and perchlorates; boron, e.g. borax, borate; strontium; and/or free chloride. Also, it is increasingly preferred in the order given, independently for each preferably minimized ingredient listed below, that cured adhesives according to the invention, contain no more than 1.0, 0.5, 0.35, 0.10, 0.08, 0.04, 0.02, 0.01, 0.001, or 0.0002 percent, more preferably said numerical values in parts per thousand (ppt), of each of the following constituents: organic filler, thickener, chromium, nitrite ions, formaldehyde, formamide, hydroxylamines, ammonia; rare earth metals; elemental sulfur and/or compounds thereof; permanganate; chlorites and perchlorates; boron, e.g. borax, borate; strontium; and/or free chloride.

A “copolymer” means all polymers composed of two or more different monomers. Configuration of comonomers present in the copolymer is not particularly limited unless specified otherwise. The copolymer may be a block copolymer, a random copolymer, an end-capped copolymer or a telechelic copolymer.

The term “paint” as used herein includes all like materials that may be designated by more specialized terms such as lacquer, enamel, varnish, shellac, topcoat, and the like; and, unless otherwise explicitly stated or necessarily implied by the context. The simple term “metal” or “metallic” will be understood by those of skill in the art to mean a material, whether it be an article or a surface, that is made up of atoms of metal elements, e.g. aluminum, the metal elements present in amounts of at least, with increasing preference in the order given, 55, 65, 75, 85, or 95 atomic percent, for example the simple term “aluminum” includes pure aluminum, those of its alloys and surfaces of aluminum that contain at least, with increasing preference in the order given, 55, 65, 75, 85, or 95 atomic percent of aluminum atoms. A bare metallic surface will be understood to mean a metallic surface in the absence of a coating layer, other than oxides of metals derived from the metallic surface through aging in air and/or water.

Other than in the operating examples, or where otherwise indicated, all numbers expressing quantities of ingredients, reaction conditions, or defining ingredient parameters used herein are to be understood as modified in all instances by the term “about”. Throughout the description, unless expressly stated to the contrary: percent, “parts of”, and ratio values are by weight or mass; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description or of generation in situ within the composition by chemical reaction(s) between one or more newly added constituents and one or more constituents already present in the composition when the other constituents are added; molecular weight (MW) is weight average molecular weight M_{w} unless otherwise specified; the word “mole” means “gram mole”, and the word itself and all of its grammatical variations may be used for any chemical species defined by all of the types and numbers of atoms present in it, irrespective of whether the species is ionic, neutral, unstable, hypothetical or in fact a stable neutral substance with well-defined molecules; and the terms “storage-stable” or “shelf stability” is to be understood as including uncured compositions that show viscosity increases of no more than 10%, preferably less than 10% over a period of observation of at least in increasing order of preference 100, 1000, 1500, 2000 or 2500 hours, e.g. preferably 30, 60 or 90 days, during which the material is mechanically undisturbed and the temperature of the material is maintained at ambient room temperature in a range of about 15° C. to 40° C. (about 60° F. to 104° F.). Preferably after storage under the above described conditions, lap shear test performance, as described herein, is equivalent to initial test performance. Viscosity may be measured by means known to those of skill in the art, e.g. Mooney test apparatus, Brookfield viscometer or parallel plate rheology.

### BRIEF DESCRIPTION OF THE DRAWINGS

FIG. 1 shows a cross-sectional view of a shear test piece used in measurements of lap shear strength and ratios of decrease in strength by high temperature heating in the Examples.

FIG. 2 shows a front view of a shear test piece used in measurements of lap shear strength and ratios of decrease in strength by high temperature heating in Examples. Arrows indicate tensile direction of testing.

### DESCRIPTION OF EMBODIMENTS

A thermally curable composition of an embodiment of the present invention comprises:
a component (a) comprising:
   (a1) at least one solid rubber; preferably based on styrene and butadiene monomers, present in an amount of about 8 to 20 wt. % based on the total weight of the composition;
   (a2) at least one olefinic double bond-containing polymer, which is liquid or pasty at 22° C., present in an amount of about 4 to 20 wt. % based on the total weight of the composition; and
   (a3) processing oil; such as petroleum base oil or natural or synthetic equivalents, preferably paraffinic oil; present in an amount of about 5 to30 wt. % based on the total weight of the composition;
   (a4) a liquid polydiene, different from (al)-(a3) present in an amount of about 1 to 20 wt. % based on the total weight of the composition;
and
a component (b) comprising:
   (b1) quinone dioxime in an amount of 0.1 to 5.0 wt. %, preferably 0.3 to 2.0, more preferably 0.1-1.0, most preferably 0.15-0.5 percent by weight based on the total weight of the composition;
   (b2) an organic curing agent, preferably organic peroxide, in an amount of 0.05 to 5.0%, preferably 2.0 to 4.5 wt. % based on the total weight of the composition; and
   (b3) a multifunctional coagent comprising a monomer, oligomer or polymer having a plurality of reactive sites of unsaturation, e.g. a plurality of α,β-unsaturated carbonyl functional groups, the multifunctional coagent being present in an amount of 0.1 to 10 wt. %, preferably 0.3 to 7 wt. % based on the total weight of the composition.

A cured adhesive, sealant or acoustic attenuating product can be obtained from the thermally curable composition of the present invention when cured in a wide temperature region of about 130° C. to about 200° C. and decrease in strength due to low or high temperature curing is reduced as compared to like compositions that require 160° C.-200° C. to cure. In the present specification, a cured product is also described as a “cured material.” As used herein the phrase “cured product” means that the composition is crosslinked to a significant extent to be solid and no longer flowable, providing good sealant properties, and/or adhesive properties such as providing a bonding strength (lap shear test performance) to join substrates.

In the present specification, a “thermally curable composition” is sometimes simply described as a “composition.” In addition, in description of the composition herein, an amount described by “%” represents wt. % based on the total weight of the composition unless otherwise specified. In the present specification, “average molecular weight” represents the mass average molecular weight of a polymer unless otherwise specified, and is specifically obtained by using gel permeation chromatography (GPC), and converting molecular weight using a calibration curve using polystyrenes having monodisperse molecular weight as standard materials.

The thermally curable composition, its components, the cured material thereof, and use of them, and processes for producing them according to the present invention will be described in detail below.

### Component (a): Resin Component

### (a1) Solid Rubber

As the solid rubber (including a thermoplastic polymer which exhibits elastomer elasticity at room temperature (22° C.)) (a1), for example, solid rubbers based on polybutadiene, styrene butadiene rubbers (styrene/butadiene/styrene copolymers (SBS)), butadiene/acrylonitrile rubbers, styrene/isoprene rubbers (styrene/isoprene/styrene copolymers (SIS)), styrene-ethylene/propylene-styrene copolymers (SEPS), styrene-ethylene/ethylene/propylene-styrene copolymers (SEEPS), optionally some styrene may comprise a second unsaturated functional group; the amount of styrene in the above copolymer, if present, may be of 10 wt. % or more, more preferably 15 wt. % or more, most preferably 20 wt. % or more, and preferably has a styrene content of 50 wt. % or less, more preferably 40 wt. % or less, most preferably 30 wt. % or less. Other examples of solid rubber may be used including synthetic or natural isoprene rubbers, polyoctenamers, butyl rubbers, and polyurethane rubbers. Solid rubbers (a1) may comprise one or a combination of two or more the solid rubbers described herein. Preferably where more than one solid rubber is used, polymers and copolymers different from each other, which may be based on the same monomers or different monomers may be selected.

The molecular weight and the like of the solid rubber are not particularly limited as long as they are in ranges in which the solid rubber exhibits elastomer elasticity at room temperature (22° C.). For example, the Mooney viscosity (ML1+4 (100° C.)) of the solid rubber is not particularly limited, but preferably in the range of 20 to 60, more preferably in the range of 30 to 50. The Mooney viscosity can be measured according to ASTM D 1646.

Examples of the “solid rubbers based on polybutadiene” include butadiene homopolymers and copolymers comprising a monomer unit other than butadiene monomer (1,3-butadiene) in a small amount (for example, 10 mol % or less). Here, examples of the monomer unit other than butadiene monomer include conjugated dienes such as isoprene, 1,3-pentadiene, 2-ethyl-1,3-butadiene, 4-methylpentadiene, and 2,4-hexadiene; acyclic monoolefins such as ethylene, propylene, butene, and pentene; cyclic monoolefins such as cyclopentene, cyclohexene, and norbornene; and nonconjugated diolefins such as dicyclopentadiene and 1,5-hexadiene. In addition, the solid rubbers based on polybutadiene preferably have a high cis content, and preferably have a cis-1,4-double bond content of 80% or more, preferably greater than 85%, most preferably 95% or more.

In the present invention, the solid rubber (a1) is present, in increasing order of preference, in an amount of at least about 8.0, 8.5, 9.0 9.5, 10.0, 10.25, 10.5, 10.75, 11.0, 11.25, 11.50, 11.75, 12.0, 12.25, 12.50, 12.75, 13.0, 13.25, 13.50 or 14.0 wt. %, based on the total amount of the composition. When the content of the solid rubber is 8.0 wt. % or more, the balance between strength and flexibility properties can be ensured. In addition, the content of the solid rubber is preferably 20 wt. % or less, and present, in increasing order of preference, in an amount of no more than about 19.5, 19.0, 18.5, 18.0, 17.5, 17.0, 16.5, 16.0, 15.5, or 15.0 wt. %. When the content of the solid rubber is 20 wt. % or less, the viscosity of the uncured material permits pumping without addition increased amounts of plasticizer. Plasticizer at high concentration may reduce adhesion and/or may tend to leach from the formulation or cured adhesive. In embodiments where the composition is applied at elevated temperature (greater than ambient), higher solid rubber/solid polymer content in a range of 17-25 or even 30 wt. % may be desirable, while embodiments applied at ambient or lower temperature may benefit from lower solid rubber content in a range of 9.0 to 12.0 wt. %.

### (a2) Olefinic Double Bond-Containing Polymer Which is Liquid or Pasty at 22° C.

The olefinic double bond-containing polymer(s), which is liquid or pasty at 22° C., is different from (a1), and may be selected to control viscosity of the composition, as well as tensile strength, elongation and improved adhesion to aluminum of the cured material. In the present specification, the “olefinic double bond-containing polymer which is liquid or pasty at 22° C. (a2)” is also referred to as the “olefinic double bond-containing polymer (a2).” The olefinic double bond-containing polymer may be a single polymer or a mixture of two, three, four or more olefinic double bond-containing polymers.

The olefinic double bond-containing polymer (a2) preferably has a glass transition temperature (Tg) below room temperature (about 20 to 30° C.). Specifically, the glass transition temperature may generally be about −110, −100, −95, −90, −80, −70, −60, −50, −40, −30, −20, −10,0° C., and is preferably less than 20° C. or 15° C. Here, “liquid” means such a state that the polymer can be poured out of a container under influence of gravity, and “pasty” means such a state that the polymer can be smoothed out to a flat uniform layer. In addition, in the present specification, the glass transition temperature means a value measured according to ASTM-D3418 using “differential scanning calorimetry (DSC).” The polymer may be a homopolymer or a copolymer. Mixtures of two or more olefinic double bond-containing polymers generally exhibit a similar Tg as described above, while the individual polymers in the mixture may have lower or higher Tg than the mixture, e.g. Tg as low as −100° C. or greater than ambient temperature provided that the mixture is liquid or pasty at room temperature (22° C.).

In one embodiment, the olefinic double bond-containing polymer (a2) may preferably be a polymer of a diene and/or an aromatic substituted olefin, and may be a copolymer of styrene and a diene from the viewpoint of improving the vibration damping properties of the cured material. The polymer of a diene can be a polydiene such as polybutadiene, polyisoprene, or a mixture of polydienes, and optionally diene copolymers.

In an embodiment, the polydiene, one having functional groups in main and/or side chain is also effective. Examples of the functional groups include carboxyl group, hydroxy group, and amine group, and the polydiene may contain two or more functional groups in combination. From the viewpoint of adhesiveness to a metal substrate, the liquid polydiene preferably comprises carboxyl group. The functional group should be present in at least one of the main chain and side chain, and may be present at any position, for example, at the end of chain or in the middle of chain in the main chain or the side chain, but is preferably present at at least the end of chain.

The copolymer of styrene and a diene, if present, preferably has a styrene content of 10 wt. % or more, more preferably 15 wt. % or more, and preferably has a styrene content of 50wt. % or less, more preferably 30 wt. % or less. When the styrene content is in the above range, excellent dissipative vibration attenuation characteristics (that is, the characteristic of converting mechanical vibration energy to heat) can be achieved.

In one embodiment, the olefinic double bond-containing polymer may comprise a combination of two or more diene polymers. The diene polymers may be homopolymers or copolymers of butadiene, isoprene, and the like. The diene polymers may be cis, trans or a mixture thereof, and may have active functional groups such as carboxyl groups. Preferably, one or more of the diene polymers have a majority of cis bonds. In a preferred embodiment, one of the olefinic double bond-containing polymers is or comprises a polybutadiene maleic anhydride adduct, preferably average molecular weight M_{w} may be less than 10,000, 5,000, 4,500, 3,000 Daltons and at least 750, 775, 800, 850, 900 Daltons. Independently preferably the polybutadiene maleic anhydride adduct includes at least in increasing order of preference 4, 4.5, 5, 5.5, 6, 6.5, 7 wt. % and preferably no more than in increasing order of preference 20, 18, 16, 14, 12, 10 wt. % of maleic anhydride units based on total weight of the maleic anhydride grafted polybutadiene.

In another embodiment of the present invention, the above olefinic double bond-containing polymer (a2) may be preferably selected from non-functionalized liquid polybutadiene, which contributes to viscosity and tensile properties; liquid polybutadiene with active carboxyl groups, which contribute to adhesion to aluminum; and liquid polyisoprene, which contributes to elongation and tensile properties; preferably a combination of two or more of said polydienes.

The positions of olefinic double bonds formed in the polymer chain by polymerization of the diene are not particularly limited, in one embodiment for curing properties and acoustic attenuation performance, the olefinic double bond-containing polymer (a2) is formed so that it comprises an unsaturated diene fraction. The ratio of the vinyl fraction in this diene fraction (that is, the ratio of 1,2 vinyl bonds to all olefinic double bonds) is not particularly limited. In some embodiments, vinyl fraction may range from 1 mol % to 50 mol %, preferably 1 mol % to 16 mol %, but in some embodiments may be as high as 70-80 mol %.

The mass average molecular weight of the olefinic double bond-containing polymer (a2) is not particularly limited, but is preferably 1,000 or more, more preferably 2,000 or more, and further preferably 5,000 or more, and is preferably 75,000 or less, more preferably 65,000 or less, and further preferably 55,000 or less. The olefinic double bond-containing polymer (a2) particularly preferably has a mass average molecular weight in the range of 5,000 to 55,000. The olefinic double bond-containing polymer (a2) preferably has the above structure and the above mass average molecular weight. The olefinic double bond-containing polymers (a2) may be used alone, or in combination of two or more polymers different from each other in one or more characteristics, type and quantity of monomer(s) used, function groups, viscosity, molecular weight, Tg and stereochemistry (cis/trans content).

The content of the olefinic double bond-containing polymer (a2) is preferably at least 5 wt. % or more, more preferably 7 wt. % or more, based on the total weight of the composition in order to obtain sufficient elongation and tensile properties and adhesion to metal, in particular aluminum, performance. In addition, the content of the olefinic double bond-containing polymer (a2) is preferably 15 wt. % or less, more preferably 12 wt. % or less, based on the total weight of the composition in order to maintain strength. at least about 5.0, 5.5, 6.0, 6.5, 7.0, 7.25, 7.5, 7.75, 8.0, 8.25, 8.50, 8.75, 9.0, 9.25, 9.50, 9.75, 10.0, 10.25, 10.50 or 11.0 wt. %, based on the total amount of the composition. When the content of the olefinic double bond-containing polymer is at least 5.0 wt. % or more, adequate cross-linking can be achieved supporting high strength. In addition, the content of the olefinic double bond-containing polymer is preferably 18 wt. % or less, and present, in increasing order of preference, in an amount of no more than about 16.5, 16.0, 15.5, 15.0, 14.5, 14.0, 13.5, 13.0, 12.5, or 12.0 wt. %. When the content of the olefinic double bond-containing polymer is 18 wt. % or less, the uncured adhesive retains viscosity suitable for pumping at ambient temperature. In embodiments where the composition is applied at elevated temperature (greater than ambient), higher olefinic double bond-containing polymer/solid polymer content in a range of 19-25 or even 30wt. %.

### (a3) Petroleum Base Oil or Natural or Synthetic Equivalent

The composition of the present invention may further comprise (a3) a petroleum base oil or natural or synthetic equivalents, preferably paraffinic oil. (a3) may act as processing lubricant, a diluent for other components or for the composition, and/or as a plasticizer. When the composition comprises the (a3), it is possible to improve the processability of the composition, and improve the mechanical characteristics of the cured material. The content of the base oil (a3) is not particularly limited, but is generally 40 wt. % or less, preferably 30 wt. % or less, and more preferably 25 wt. % or less, and is preferably 2 wt. % or more, more preferably 5wt. % or more, based on the total amount of the composition, for example 15-20 wt. % thereof.

Examples of the materials useful as (a3) include hydrocarbon oils, for example, white oils; and natural oils; which are liquid at 22° C. (for example, fatty acid glycerin esters such as the so-called triglycerides, for example, rapeseed oil, soybean oil, walnut oil, linseed oil, sunflower oil, and olive oil) or phthalic acid esters. In one embodiment, processing oils are used, which are lower in viscosity. Naphthenic and/or paraffinic oil may be used. Paraffinic oil provides the compositions with the lowest viscosity at the same weight percent loading level compared to other processing oils, which is preferred. The lower viscosity permits a higher rubber to plasticizer ratio, which contributes to improved performance at low temperature curing. Depending on viscosity of the (a3) additive selected, relative amounts solid rubber and liquid rubber may be adjusted. For example phthalates may be used in compositions having less solid rubber and more liquid rubber.

### (a4) Liquid Polydiene

A liquid polydiene (a4), different from (a1-a3), having low viscosity may be used in compositions of the invention. Examples of the diene monomer of the polydienes include Ethylene propylene diene, butadiene, isoprene, and chloroprene; examples of the polydiene oligomer or polymer include homopolymers or copolymers of the diene monomers, optionally partially hydrogenated, as well as hydroxylated derivatives of said oligomers and polymers. Among them, preferred liquid polydienes (a4) include polybutadiene, polyisoprene, and the like, and particularly preferred is polybutadiene.

In some embodiments the liquid polydiene, for example polybutadiene, preferably may have a high content of cis bonds in the polymer. In one embodiment, the liquid polydiene comprises polybutadiene having a cis-1,4-double bond content of approximately 50% or more. In another embodiment, the liquid polydiene, preferably has a cis-1,4-double bond content of greater than 85%, most preferably 80% or more. The liquid polydiene compound preferably has a mass average molecular weight M_{w} such that the polydiene is liquid at room temperature (22° C.). For example, MW of the polydiene may be in a range of 500 to 50,000 Daltons, more preferably in the range of 1000 to 10,000. In addition, the liquid polydiene preferably has a glass transition temperature of less than −50° C., preferably less than −60° C., most preferably less than −90° C.

The content of the liquid polydiene (a4) is preferably 3 wt. % or more, more preferably 5 wt. % or more, based on the total amount of the composition. In addition, the content of the liquid polydiene is preferably 20 wt. % or less, more preferably 10 wt. % or less, based on the total amount of the composition. When the composition comprises the liquid polydiene (a4) present in an amount of about 3 wt. % to 20 wt. %, the vibration damping properties and adhesiveness of the cured material obtained from the composition are likely to be improved.

In an alternative embodiment, solid rubber (a1) is present in an amount of less than 8%, preferably in a range of 1-7%, most preferably less than 1%, and in a particularly preferred embodiment no solid rubber (a1) is present. This embodiment comprises higher amounts of (a4) at least one olefinic double bond-containing polymer, selected such that the polymer may be a low viscosity or higher viscosity liquid (suitable viscosities typically are less than 1200 Pa-sec @38 deg). Generally the (a4) polymer in this embodiment may have a low molecular weight (1700-55,000 Daltons), and may be a liquid rubber, for example polybutadiene, natural rubber, isoprene rubber, SBR.

### Optional Hydrocarbon Resin

The optional hydrocarbon resin can be added as a diluent, plasticizer or tackifier. The content of the hydrocarbon resin is preferably 0 to 15 wt. % based on the total weight of the composition, and if used the lower limit is preferably 1 wt. % or more, further preferably 5 wt. % or more, and the upper limit is preferably 12 wt. % or less, further preferably 10 wt. % or less. When the composition comprises the hydrocarbon resin, the cured material exhibits vibration damping properties as described above, and when the content is 15 wt. % or less, decrease in strength of the cured material when the composition is heated at high temperature can be suppressed. Particularly, by including the above-described plasticizer and the hydrocarbon resin in the composition, the acoustic attenuation characteristics can be improved at a temperature in the range of −5° C. to 40° C.

The hydrocarbon resins can be totally aliphatic or totally aromatic or they can possess aliphatic and aromatic structures. Moreover, they can be aromatically modified aliphatic resins. In each case, the hydrocarbon resin particularly preferably has compatibility with other polymer components. Examples of the hydrocarbon resins include natural hydrocarbon resins such as terpene resins (for example, terpene resins, hydrogenated terpene resins, and aromatic modified terpene resins) and rosin resins (for example, rosins and modified rosins such as hydrogenated rosins, disproportionated rosins, and polymerized rosins); and synthetic hydrocarbon resins such as petroleum hydrocarbon resins, coumarone-indene resins, xylene resins, and styrene resins, and among them, petroleum hydrocarbon resins are preferred.

For the petroleum hydrocarbon resins, petroleum hydrocarbon resins obtained by polymerizing a fraction containing an unsaturated hydrocarbon monomer produced as a by-product by thermal cracking of petroleum naphtha or the like can be preferably used, and specific examples of the petroleum hydrocarbon resins include C5 aliphatic petroleum resins, C9 aromatic petroleum resins, C5/C9 petroleum resins, and hydrogenated petroleum resins obtained by hydrogenating C9 or C5/C9 petroleum resins, and alicyclic petroleum resins such as dicyclopentadiene petroleum resins. These may be used alone, or in combination of two or more of these.

### Component (b): Curing System Component

### (b1) Quinone Dioxime

The composition according to the present invention comprises as curing system having components: (b1) a quinone dioxime in an amount of 0.1 to 5.0 wt. % based on the total weight of the composition; (b2) an organic curing agent, preferably organic peroxide, in an amount of 0.1 to 5.0 wt. % based on the total weight of the composition; and (b3) multifunctional, preferably at least one tri-functional, (meth)acrylate monomer, oligomer or polyol, in an amount of 0 to 10 wt. %, preferably 0.1 to 9 wt. %, based on the total weight of the composition. By increasing the amount of (b2) and (b3), the amount of quinone dioxime may be reduced or eliminated.

The quinone dioxime (b1), rubber cross-linker & adhesion promoter. The quinone dioxime produces cross-links that are resistant to reversion at high temperatures (190-210° C.). The roofs of automobiles tend to reach such temperatures during e-coat curing, which can break cross-links based on other curatives, such as sulfur.

In some embodiments, the quinone dioxime (b1) may be blended into the composition as a mixture of an active component (that is, a compound having a curing effect, i.e. cross-linking) and a compound other than the active component. “The content of the quinone dioxime” in the present invention means the content of only the effective component. When the content of curing components in the composition are in the above ranges respectively, the cured material has sufficient adhesive strength, and exhibits less of a decrease in strength when the composition is cured by high temperature heating.

The composition according to the invention preferably contains no added elemental sulfur; trace amounts of sulfur may be present in low amounts, for example in increasing order of preference less than 1.0, 0.5, 0.25, 0.1, 0.05, 0.025 or 0.001 wt. %, these amounts preferably in parts per thousand, most preferably in parts per million elemental sulfur. Benefits of lower or no elemental sulfur include better shelf life for single package adhesive (“1K adhesive”), compatibility with some electrodeposition paint coatings (often referred to in the art as “e-coat” paint) that are sensitive to or produce undesirable reactions with sulfur-containing adhesives.

### (b2) An Organic Peroxide Curing Agent

In various embodiments, the cure system is a peroxide-based cure system. In corresponding embodiments, the at least one peroxide compound contained in a composition according to the invention is preferably selected from the group consisting of dibenzoyl peroxide, tert-butyl peroxybenzoate, and in particular 1,1-di-(tert-butylperoxy)-3,3,5-trimethylcyclohexane, butyl 4,4-di-(tert-butylperoxy) valerate, dicumyl peroxide, di-(2-tert-butyl-peroxyisopropyl)-benzene, tert-butylcumyl peroxide, 2,5-dimethyl-2,5-di-(tert-butylperoxy) hexane, di-tert-butyl peroxide, 3,3,5,7,7-pentamethyl-1,2,4-trioxepane, tert-butylperoxy-2-ethylhexyl carbonate, di(4-methylbenzoyl) peroxide, di(2,4-dichlorobenzoyl) peroxide, 2,5-dimethyl-2,5-di(tert-butylperoxyl) hexane and di-tert-butyl-1,1,4,4-tetramethylbut-2-yne-1,4-ylene diperoxide.

In some embodiments, the amount of peroxide compound is about 0.1% to about 7% by weight, for example about 0.1, 0.2, 0.3, 0.4, 0.5, 0.6, 0.7, 0.8, 0.9, 1.0, 1.5, 2.0, 2.5, 3.0, 3.5, 4.0, 4.5, 5.0, 5, 5, 6.0, 6.5 or 7.0% by weight, preferably about 0.1% to about 5% by weight, for example about 0.15, 0.25, 0.35, 0.45, 0.55, 0.65, 0.75, 0.85, 0.95, 1.05, 1.1, 1.2, 1.4, 1.7, 1.9, 2.1, 24, 2.6, 2.8, 3.3, 3.7, 4.1, 4.6, 4.9 or 5.0% by weight, based on the total weight of the composition.

In various embodiments, the curing system is a peroxide-based curing system, and the composition of the invention contains at least one peroxide compound in an amount from about 0.1% to about 7% by weight, preferably from about 0.1% to about 5% by weight, based on the total weight of the composition. In other embodiments, the organic peroxide may be present in an amount in a range of 2.0 to 4.5 wt. %.

The inventors of the present invention have found that when sulfur and sulfur accelerators, as described herein, are absent from the curing system, and the thermally curable composition comprises quinone dioxime in an amount greater than 0.1 wt. %, e.g. 0.2-0.6 wt. %, in the presence of organic peroxide, the components of the curing system synergistically achieved improved adhesive LSS results cured at 140° C. on aluminum and suppressed decrease in strength of the cured material subjected to heat cure at high temperature. Particularly when the composition of the present invention does not comprise sulfur and sulfur accelerators conventionally used in a thermally curable composition, decrease in strength of the cured material due to high temperature heating (overbaking) was observed to be within acceptable limits.

Examples of the organic curing agent also include other curing systems other than the above, provided that they do not interfere unduly with objects of the invention. Examples of the other vulcanization systems include quinones, nitrosobenzene, and dinitrosobenzene (particularly p-dinitrosobenzene). In some embodiments, dioxime quinone is preferred for use with the organic peroxides.

### (b3) Multifunctional Coagents

A multifunctional coagent comprising a monomer, oligomer or polymer having a plurality of α,β-unsaturated carbonyl functional groups (b3), may be included in the composition in an amount of 0.1 to 10 wt. % based on the total weight of the composition. Desirably, the multifunctional coagent comprises a plurality of reactive sites of unsaturation, which are not particularly limited. In some embodiments, the sites of unsaturation comprise two, three or more α,β-unsaturated carbonyl functional groups, for example a plurality of (meth)acrylate terminal functional groups, preferably multifunctional acrylate and methacrylate esters. The multifunctional (meth)acrylate may be di- tri- or more substituted, meaning that the molecule has 2, 3 or more sites of ethylenic unsaturation. In one embodiment, (b3) comprises a trimethacrylate, a triacrylate, a diacrylate, a dimethacrylate or combination of two or more of these coagents. In some embodiments, the (meth)acrylate terminal functional groups are separated by a linear or branched C2-C12 alkyl group, or by one or more EO or PO groups.

The multifunctional (meth)acrylate monomer, oligomer or polymer (b3), are not particularly limited provided that they do not negatively impact low temperature curing, storage stability, reversion resistance or other objects of the invention. Examples of (b3) materials may include monomers such as trimethylolpropane triacrylate (TMPTA), trimethylolpropane trimethacrylate (TMPTMA), ethylene dimethacrylate (EDMA), diethylene glycol dimethacrylate (EGDMA), ethylene glycol dimethacrylate (DEGDMA), pentaerythritol tri(meth)acrylate (PETRA; PETRMA) and pentaerythritol tetraacrylate (PETTA); 1,1,1-tris[4-(2′-hydroxy-3′-methacryloyloxypropoxy)phenyl]ethane (THMPE) and 1,1,1-tris[4-(2′-hydroxy-3′-methacryloyloxypropoxy)phenyl]methane (THMPM); hydroxy functional monomer such as 3-(acryloyloxy)-2-hydroxypropyl methacrylate. Multifunctional (meth)acrylate oligomers and polymers such as alkoxylated trimethylolalkane tri(meth)acrylates, for example ethoxylated (3) trimethylolpropane triacrylate (EO3), propoxylated (3) trimethylolpropane triacrylate (PO3) may also be used. Preferred are di- and tri-(meth)acrylates, understood to mean a member of the group of di- and tri-acrylates and di- and tri-methacrylates, desirably having a molecular weight of at least about 198 and up to about 500 Daltons. Trimethylolpropane triacrylate (TMPTA), Ethoxylated (3) Trimethylolpropane Triacrylate (EO3), Propoxylated (3) Trimethylolpropane Triacrylate (PO3), Ethylene dimethacrylate (EDMA) and ethylene glycol dimethacrylate (EGDMA) are commonly used.

In certain embodiments of the composition of the present invention, the thermally curable composition and cured products thereof may comprise one or more additives such as blowing agent (optional), filler(s), flame retardant, colorant (e.g. carbon black), moisture absorbent, antioxidant and plasticizer, and the like, which may be used in combination with the above-described components.

### Component (c): Blowing Agent

In one embodiment of the present invention, the composition may comprise a blowing agent so as to expand (foam) irreversibly before or during thermal curing, and preferably comprises (c1) a physical blowing agent in an amount of 0 to 3 wt. % based on the total weight of the composition, and (c2) a chemical blowing agent in an amount of 0 to 4 wt. % based on the total weight of the composition. The irreversible expansion of the blowing agent causes an irreversible volume increase that enables cavities or intermediate spaces to be more completely filled with the cured compound. For highly expanding materials, greater than 100% or more expansion chemical blowing agents are preferred.

The content of the (c1) physical blowing agent in the composition is not particularly limited, but is preferably 0 to 3 wt. %, more preferably 0.1 wt. % to 2.5 wt. %, and further preferably 0.2 wt. % to 2.0 wt. %, based on the total weight of the composition.

As the “physical blowing agent,” resin blowing agents which expand by heat (thermally expandable resin blowing agents) are preferred, and expandable plastic hollow microspheres which expand by heat are more preferred. Physical blowing agents useful in the invention may be comprised of thermo-expandable microspheres containing a low-boiling-point liquid hydrocarbon inside a thermoplastic polymer shell. When heated, the shells soften and, at the same time, the hydrocarbon contained inside expands, forming micro-balloons. Examples of the thermally expandable resin blowing agents include those based on polyvinylidene chloride copolymers or acrylonitrile/(meth)acrylate copolymers. These are commercially available, for example, under the name of “Dualite (registered trademark)” or “Expancel (registered trademark)” from Pierce & Stevens and Casco Nobel respectively.

Examples of (c2) “chemical blowing agent” include those which emit gases by decomposition, and are typically referred to as exothermic blowing agents and endothermic blowing agents. Exothermic blowing agents include azobisisobutyronitrile, azodicarbonamide, dinitrosopentamethylenetetramine, 4,4′-oxybis (benzenesulfonic acid hydrazide), diphenylsulfone-3,3′-disulfohydrazide, benzene-1,3-disulfohydrazide, and p-toluene sulfonyl semicarbazide.

Endothermic chemical blowing agents are often bicarbonates, solid, optionally functionalized, polycarboxylic acids and their salts, and mixtures thereof. Suitable bicarbonates (bicarbonates) are those of the formula XHCO3, wherein X may be any cation, in particular an alkali metal ion, preferably Na+ or K+, with Na+ being highly preferred. Other suitable cations X+ may be selected from NH 4 +, ½ Zn 2+, ½ Mg 2+, ½ Ca 2+ and mixtures thereof. Particular preference is given to using sodium and/or potassium bicarbonate, in particular sodium bicarbonate. Suitable polycarboxylic acids include, but are not limited to, solid, organic di-, tri-, or tetra-carboxylic acids, especially hydroxy-functionalized or unsaturated di-, tri-, tetra-, or polycarboxylic acids, such as citric, tartaric, malic, fumaric, and maleic acids. Particularly preferred is the use of citric acid. One of the benefits of citric acid is that it is an environmentally sustainable propellant.

Also suitable are the salts of said acids and mixtures of two or more of the compounds described. In the case of salts of the polycarboxylic acids, the counterion is preferably selected from Na+, K+, NH 4 +, ½Zn 2+, ½Mg 2+, ½Ca 2+ and mixtures thereof, Na+ and K+, in particular Na+, being preferred. In particular, the salts of polycarboxylic acids show decomposition temperatures shifted towards higher temperatures, so that a broader temperature interval of the decomposition can be adjusted by blending. In the case of the use of polycarboxylic acids, carbonates can also be used in addition. Preference is given to a mixture of bicarbonates and carbonates and polycarboxylic acids, whereby specifically different activation stages and decomposition reactions can be set.

Particularly preferred blowing agents are sodium bicarbonate and/or citric acid/citrates, most preferably the blowing agent is a mixture of sodium bicarbonate and citric acid. Such a mixture has a low starting temperature of only 120-140° C. compared to conventional exothermic blowing agents such as ADCA or OBSH, where OBSH has a starting temperature of 140-160° C. and ADCA activates with zinc salts a starting temperature of 160-170° C.

To facilitate lower starting temperatures for ADCA or OBSH, urea in an amount of about 0.1-0.5 wt. % may be included in these blowing agents. It has been reported that temperature of decomposition (dp in ° C.) of ADCA can be reduced to a range of 148° C.-152° C. and that of OBSH can be reduced to a range of 127° C. to 129° C.

Endothermic blowing agent which may be s a mixture of polycarboxylic acid and an inorganic carbonate, the polycarboxylic acid and the inorganic carbonate each having been surface treated with a component which prevents water from being absorbed thereby.

The content of the (c2) chemical blowing agent in the composition is preferably 0 to 0.2 wt. %, more preferably 0 to less than 0.2 wt. %, based on the total weight of the composition, and the composition further preferably does not comprise (that is, 0 wt. %) the (c2) exothermic chemical blowing agent. The inventors of the present invention have found that when the content of a chemical blowing agent usually used as a blowing agent in a thermally curable composition is preferably 0.2 wt. % or less, more preferably less than 0.2 wt. %, and the composition further preferably does not comprise the chemical blowing agent, decrease in strength of the composition due to high temperature curing can be suppressed. Thus, when the composition of the present invention comprises a blowing agent, particular preference is given to such an aspect that the composition comprises a physical blowing agent and does not comprise a chemical blowing agent. It is also preferred that the composition contains less than 0.05 wt. % of exothermic chemical blowing agents, in particular azodicarbonamide or 4,4′-oxybis (benzenesulfonyl hydrazide).

In the present embodiment, whether a blowing agent is used or not can be appropriately selected according to use of the composition, and the like. For example, in use for manufacturing of vehicles, it is effective that the composition foams during a baking-curing step to reduce the strain in the external skin, and therefore a blowing agent is desirably added in a suitable range.

### Component (d): Filler

The composition of the present invention may contain a filler (d). The content of the filler is not particularly limited, but based on the total amount of the composition, the lower limit is preferably 10 wt. % or more, more preferably 15 wt. % or more, and further preferably 25 wt. % or more, and the upper limit is preferably 50 wt. % or less, more preferably 45 wt. % or less, further preferably 40 wt. % or less, and still further preferably 36 wt. % or less.

The filler can be selected from various substances, and examples of the filler include fumed silica, chalk, natural, precipitated or ground calcium carbonate, calcium magnesium carbonate, silica, talc, mica, and barite. In one embodiment, at least some of the fillers may be surface-treated. For example, in order to decrease moisture taken in the cured material, and in order to decrease the moisture sensitivity of the cured material, the filler is preferably coated with stearic acid, and examples thereof include calcium carbonate and chalk coated with stearic acid. In one embodiment, a filler having a high aspect ratio, for example, a flaky filler having a thickness which is small compared with the size of the flake surface, may be used. As the flaky filler, fillers having an aspect ratio of 10 or more (that is, the thickness in the direction perpendicular to the flake surface is 1/10 or less of the minimum area of the flake surface), for example, layered silicates (preferably mica and talc) and graphite, are preferred from the viewpoint of providing good acoustic attenuation characteristics. Use of general inorganic lightweight aggregate (glass balloons, ceramic balloons, and the like) for adjusting specific gravity is also possible.

The composition of the present invention may further contain calcium oxide in an amount of 0 to 10 wt. %, preferably 1 to 6 wt. %, and more preferably 1.5 to 5.5 wt. %, based on the total amount of the composition, in addition to the above filler, for binding moisture.

In addition, the composition of the present invention may comprise carbon black. The content of the carbon black is preferably 0.1 wt. % or more, more preferably 0.3 wt. % or more, and is preferably 3 wt. % or less, more preferably 2 wt. % or less, based on the total weight of the composition.

The composition of the present invention may optionally further comprise fibrous reinforcing filler, preferably short organic, glass or carbon fibers which are in the form of pulp fibers or staple fibers. The fiber content of the composition is not particularly limited, but is preferably 0.5 to 10 wt. % based on the total amount of the composition.

The composition of the present invention comprises the above-described component (a) and component (b), and further, preferably comprises at least one selected from the group consisting of the (c) blowing agent, the (d) filler, and plasticizer/processing oil. In some embodiments, no blowing agent or fibrous filler is present. In other embodiments, the composition comprises all of the (c) blowing agent, the (d) filler, and the plasticizer/processing oil.

Examples of aspects of components constituting the thermally curable composition of the present invention are shown in Table 1, but the present invention is not limited to these.

TABLE 1

| Component Amounts* (wt. %) | Range 1 | Range 2 | Range 3 |
|---|---|---|---|
| (a) Resin component | | | |
| (a1) Solid rubber | 0-15 | 8-20 | 5-15 |
| (a2) Olefinic Double | 0-15 | 5-15 | 7-12 |
| Bond-Containing Polymer, | | | |
| Liquid or Pasty at 22° C. | | | |
| (a3) Paraffinic oil; | 0-40 | 5-30 | 15-20 |
| (a4) Liquid polydiene | 0-20 | 1-10 | 2-7 |
| (b) Curing System | | | |
| (b1) Quinone Dioxime | 0-2 | 0.1-1 | 0.15-0.5 |
| (b2) Organic peroxide | 0.1-5 | 0.2-5 | 0.2-2.0 |
| curing agent | | | |
| (b3) multifunctional | 0-10 | 0.1-9 | 0.3-7 |
| (meth)acrylate monomer, | | | |
| oligomer or polyol | | | |
| (c) Blowing agent | | | |
| Chemical blowing agent | 0-4 | 0-2 | 0.1-1.5 |
| Physical blowing agent | 0-3 | 0-2 | 0.2-2 |
| a urea-based blowing agent | 0-1 | 0.1-0.5 | 0.2-0.45 |
| accelerator | | | |
| (d) Filler | | | |
| Calcium carbonate, graphite, | 15-50 | 20-45 | 25-40 |
| silicate fillers e.g. talc, mica, | | | |
| ceramic balloons, fumed silica | | | |
| Carbon black | 0-1 | 0.1-3 | 0.3-2 |
| Calcium oxide (moisture absorbent) | 0-10 | 1-6 | 1.5-5.5 |
| Antioxidant | 0-1 | 0.1-1.0 | 0.2-0.7 |
| Flame Retardant | 0-10 | 2-9 | 3-8 |

*Amounts are given in % based on the total weight of the composition and total component amount does not exceed 100% of the composition.

The composition of the present invention is not limited to the compositions described in the above Table 1, and the amounts of the components blended may be changed, and the composition can contain fibers, another typical curing accelerator and/or crosslinking agent, another antioxidant, coactivator, catalyst, oil, resin, anti-aging agent, rheological aid, adhesion accelerator, pigment, thermoplastic polymer, and/or the like, in addition to the components illustrated above, or in place of any of the components illustrated above.

The composition of the present invention can be produced, for example, by introducing the above-described components into a mixing machine such as a bead mill, a grinding machine, a pot mill, a three-roll mill, a rotary mixer, or a twin screw mixer, and mixing them at a temperature less than what is required to initiate curing.

The composition of the present invention is a mixture of a plurality of components which are liquid or solid at 22° C., and an advantage of the composition is that the mixing ratio of the components can be appropriately adjusted in the range which does not impair the effect of the present invention. Therefore, in one embodiment of the present invention, the ratio of the components can be adjusted so that the composition can be subjected to mechanical coating (for example, by a robot) or manual coating at a temperature of 60° C. or less by using standard coating apparatuses for adhesives and sealants in the manufacturing industry. For this, it is preferred that the above-described acoustic attenuating resin is liquid or pasty at 22° C., and as described in detail above, the solid rubber, the acoustic attenuating resin, the hydrocarbon resin, and the liquid polydiene are blended at a preferred ratio. Therefore, a composition according to a preferred embodiment of the present invention has a viscosity at a temperature in the range of 15 to 60° C. such that the composition can be pumped with a pump (a rotary pump, a gear pump, or a lift piston pump). According to the present embodiment, advantages are that it is not necessary to use a particular extrusion technique, and it is not necessary to previously make an injection-molded article or the like.

Another aspect of the present invention relates to a coating method of the composition of the present invention. Therefore, the present invention relates to a process for applying the composition of the present invention, the process comprising injecting the composition of the present invention by a pump (for example, the above-described pump) to the point of application at a temperature in the range of 15 to 60° C., whereby applying the composition in a liquid or pasty state onto a lubricated substrate, an untreated substrate, or a clean substrate.

After the application, the composition according to the present invention can be thermally cured, for which the ovens that are typically available in the industrial segment of vehicle construction and equipment construction for baking paint coatings can be used. The activation temperature for the thermal curing and the optional foaming is preferably in the range of 130 to 220° C. This temperature is preferably maintained for a period of 10 to 30 minutes.

Besides the composition of the present invention used in pump application, a formed article that is the baked and cured material of the composition of the present invention can be used as a retrofit part in a trim shop (rigging step), an aftermarket (repair market), or the like.

Another aspect of the present invention relates to a cured product (cured material) obtained by curing the composition according to the present invention. The cured material according to the present embodiment has excellent vibration damping properties (acoustic attenuation characteristics), and a small decrease in strength by heating at high temperature.

In the present embodiment, the cured material preferably has a glass transition temperature in the range of −20 to 40° C., preferably in the range of −15 to 30° C. When the glass transition temperature is in the above range, good vibration damping properties (acoustic attenuation behavior) are attained in a wide temperature range. The glass transition temperature of the cured material can be defined as the temperature at which the loss factor (tan δ) is the maximum.

The cured product according to the present embodiment can be produced by heating the composition of the present invention, for example, at a temperature in the range of 130 to 220° C. for 10 to 30 minutes. Here, the composition may be directly applied to the site of use before cure, or may be processed to form a baked and cured product used as a retrofit part.

Another aspect of the present invention relates to use of the composition according to the present invention and the cured material thereof. The composition of the present invention can be preferably used as an underlay material and an adhesive/sealant, particularly for structural attachments (for example, doors, engine hoods and trunk lids, roofs, fronts, and chassis portions), and further, in the passenger compartments of vehicles (automobiles, buses, and the like), and for production of railcars. Further, the composition of the present invention can also be preferably used in equipment construction when acoustic vibrations that can emanate from motors, gears or pumps (generally from vibrations generated by rotating machines) should be attenuated. Therefore, the present invention relates to use of the composition of the present invention as an acoustic attenuating material, an adhesive and/or sealant in vehicle and equipment construction.

### EXAMPLES

The present invention will be described in more detail below by Examples, but the present invention is not limited to these examples.

### Examples 1-6

Respective components were mixed in amounts in Table 2 to prepare the compositions of Examples 1 to 6. The lap shear strength of each of the prepared compositions was tested, as described.

TABLE 2

| Component | 1 | 2 | 3 | 4 | 5 | 6 |
|---|---|---|---|---|---|---|
| Styrene-butadiene rubber | 9.27 | 9.290 | 9.291 | 9.293 | 9.288 | 9.27 |
| Polybutadiene rubber | 1.22 | 1.223 | 1.223 | 1.223 | 1.222 | 2.4 |
| Paraffinic oil | 25.33 | 25.383 | 25.388 | 25.393 | 25.378 | 30.1 |
| Ground calcium carbonate | 33.6 | 33.671 | 33.677 | 33.684 | 33.664 | 27.44 |
| Precipitated calcium | 9.06 | 9.079 | 9.081 | 9.083 | 9.077 | 9.06 |
| carbonate | | | | | | |
| Aluminum hydroxide | 6.14 | 6.153 | 6.154 | 6.155 | 6.152 | 6.14 |
| Calcium oxide | 4.35 | 4.359 | 4.360 | 4.361 | 4.358 | 4.35 |
| Liquid diene | 2 | 2.004 | 2.005 | 2.005 | 2.004 | 2.5 |
| Maleic anhydride grafted | 6.77 | 6.784 | 6.786 | 6.787 | 6.783 | 6.77 |
| polybutadiene | | | | | | |
| Physical blowing agent | 0.28 | 0.281 | 0.281 | 0.281 | 0.281 | 0.28 |
| Chemical blowing agent | 0.18 | 0.180 | 0.180 | 0.180 | 0.180 | 0.18 |
| Quinone dioxime, 50 wt. % | 0.4 | 0.401 | 0.200 | 0.000 | 0.601 | 0.6 |
| in Naphthenic oil | | | | | | |
| Aromatic peroxide, | 0.42 | 0.210 | 0.210 | 0.211 | 0.210 | 0.105 |
| 40 wt. % in inert solid | | | | | | |
| carrier | | | | | | |
| Trifunctional methacrylate | 0.18 | 0.180 | 0.361 | 0.541 | 0.000 | |
| Antioxidant | 0.3 | 0.301 | 0.301 | 0.301 | 0.301 | 0.3 |
| Fumed silica | 0.5 | 0.501 | 0.501 | 0.501 | 0.501 | 0.5 |
| Total | 100.00 | 100.00 | 100.00 | 100.00 | 100.00 | 100.00 |

### Lap Shear Strength Testing

Compositions of Examples 1-6 were each tested on X621 Aluminum as follows:

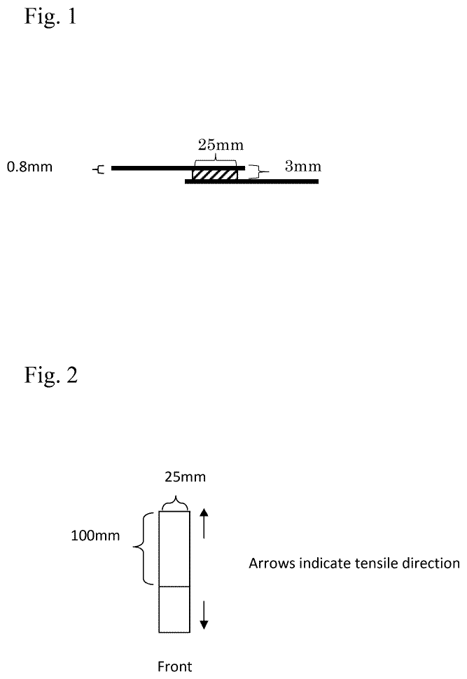

X621 Aluminum plates having a thickness of 0.8 mm and a size of 100 mm×25 mm were washed, an antirust oil was applied, and the composition was applied to one plate an area 25 mm×25 mm at a thickness of 3 mm; a second plate was applied to the composition, as shown in FIGS. 1 & 2. FIG. 1 is a cross-sectional view of the shear test piece, and FIG. 2 is a front view of the shear test piece used. For Examples 1-5, Separate shear test pieces for each example were made for different cure temperature to be applied as shown in Table 3, shear test pieces were cured at the recited temperature maintained for 20 minutes. For Example 6, four separate shear test pieces were made, one for each cure temperature. Each of the four test pieces of Example 6 was baked under cure conditions as shown in Table 3 maintained for 20 minutes, with Example 6 panels cured at 170° C., 190° C. or 290° C. being overbaked to test whether high heat cure reduced adhesive or cohesive strength. Each shear test piece was allowed to cool to ambient temperature. Thereafter, lap shear strength to failure of the bond was assessed using a general tensile tester. Each shear test piece was subjected to force applied at a controlled rate until the bond broke and the maximum force applied was recorded. The moving speed of the clamp was 50 mm/min. A qualitative review of failure mode was made visually for Examples 1-6, based on the amount of adhesive that remained on the aluminum substrate after bond failure (more adhesive showing cohesive failure being better performance). LSS results are given in kiloPascals (kPa).

TABLE 3
Lap Shear Strength (LSS)

| | Ex. 1 | | Ex. 2 | | Ex. 3 | | Ex. 4 | | Ex. 5 | | Ex. 6 | |
|---|---|---|---|---|---|---|---|---|---|---|---|---|
| | LSS (kPa) and Failure Mode | | | | | | | | | | | |
| Initial Cure | | | | | | | | | | | | |
| Conditions | | | | | | | | | | | | |
| LSS-X621 Al; | | | | | | | | | 180 | B | | |
| 130° C. | | | | | | | | | | | | |
| LSS-X621 Al; | | | | | | | | | 270 | A | | |
| 135° C. | | | | | | | | | | | | |
| LSS-X621 Al; | 230 | C | 260 | C | 130 | C | 130 | D | 290 | A | 270 | A |
| 140° C. | | | | | | | | | | | | |
| LSS-X621 Al; | 250 | A | 270 | A | 170 | C | 170 | D | 290 | A | | |
| 145° C. | | | | | | | | | | | | |
| LSS-X621 Al; | 250 | A | 270 | A | 170 | C | 170 | D | 290 | A | | |
| 150° C. | | | | | | | | | | | | |
| Overbake | | | | | | | | | | | | |
| Reversion | | | | | | | | | | | | |
| Resistance | | | | | | | | | | | | |
| LSS-X621 Al; | | | | | | | | | | | 240 | A |
| 170° C. | | | | | | | | | | | | |
| LSS-X621 Al; | | | | | | | | | | | 210 | A |
| 190° C. | | | | | | | | | | | | |
| LSS-X621 Al; | | | | | | | | | | | 190 | A |
| 200° C. | | | | | | | | | | | | |

| Performance scale | Failure Mode |
|---|---|
| A - Pass | Cohesive failure |
| B- Adhesion >50% | Predominately cohesive failure |
| C- Adhesion <50% | Predominately adhesive failure |
| D - Fail | Adhesive failure |

The above test results tend to show that some of the inventive compositions cured at 130° C. to 150° C. temperatures, which are lower than standard oven cure of 160° C.-200° C., exhibited grade A or B performance and good LSS test results. At 140° C. cure, Example 6 outperformed Examples 1-4, exhibiting LSS of 270 kPa·s. Small decreases in LSS scoring were observed for Example 6 panels overbaked in ranges of 170° C., 190° C. or 290° C. on aluminum. The overbaked panels showed significantly better LSS than Examples 3 and 4 across the entire overbake temperature window. Low bake cured compositions exhibiting overbake resistance are highly desirable in line production, where line stoppages may result in overbaking conditions.

### Examples 6-12

The effect of increasing amounts of organic peroxide and polyfunctional (meth)acrylate monomer and reducing quinone dioxime amount was examined in this set of examples. Respective components were mixed in amounts in Table 4 to prepare the compositions of Examples 6 to 12.

TABLE 4

| Component | Ex. 7 | Ex. 8 | Ex. 9 | Ex. 10 | Ex. 11 | Ex. 12 | Ex. 13 |
|---|---|---|---|---|---|---|---|
| Styrene-butadiene | 8.93 | 9.004 | 8.918 | 9.093 | 9.093 | 9.275 | 8.935 |
| rubber | | | | | | | |
| Polybutadiene rubber | 2.31 | 2.331 | 2.309 | 2.354 | 2.354 | 2.401 | 2.313 |
| Paraffinic oil | 17.35 | 17.484 | 17.316 | 17.656 | 17.656 | 18.009 | 17.349 |
| Ground calcium | 23.39 | 23.575 | 23.348 | 23.806 | 23.806 | 24.282 | 23.393 |
| carbonate | | | | | | | |
| Precipitated calcium | 8.73 | 8.800 | 8.716 | 8.887 | 8.887 | 9.065 | 8.733 |
| carbonate | | | | | | | |
| Aluminum hydroxide | 5.92 | 5.964 | 5.907 | 6.023 | 6.023 | 6.143 | 5.918 |
| Calcium oxide | 4.19 | 4.225 | 4.185 | 4.267 | 4.267 | 4.352 | 4.193 |
| Fumed silica | 0.48 | 0.486 | 0.481 | 0.490 | 0.490 | 0.500 | 0.482 |
| Liquid polybutadiene | 9.64 | 9.713 | 9.620 | 9.809 | 9.809 | 10.005 | 9.639 |
| 1,2 vinyl 15-25% | | | | | | | |
| Maleic anhydride | | 6.576 | 6.513 | 6.641 | 6.641 | 6.773 | 6.525 |
| grafted polybutadiene, | | | | | | | |
| 7.5 pbw M.A. | | | | | | | |
| Maleic anhydride | 6.53 | | | | | | |
| grafted polybutadiene | | | | | | | |
| 15 pbw M.A. | | | | | | | |
| Quinone dioxime, | 0.77 | | | | | | 0.771 |
| 50 wt. % in naphthenic | | | | | | | |
| oil | | | | | | | |
| Aromatic peroxide, | 3.86 | 3.885 | 3.848 | 3.923 | 3.923 | 4.002 | 3.855 |
| 40 wt. % in inert solid | | | | | | | |
| carrier | | | | | | | |
| Trifunctional | 0.96 | 0.971 | 1.924 | 0.981 | 1.962 | 1.001 | 0.964 |
| methacrylate | | | | | | | |
| Trifunctional acrylate | 1.93 | 1.943 | 1.924 | 0.981 | 1.962 | 1.001 | 1.928 |
| Difunctional acrylate | 1.93 | 1.943 | 1.924 | 1.962 | | | 1.928 |
| Physical blowing agent | 1.20 | 1.214 | 1.203 | 1.226 | 1.226 | 1.251 | 1.205 |
| Chemical blowing | 1.21 | 1.224 | 1.212 | 1.236 | 1.236 | 1.261 | 1.214 |
| agent | | | | | | | |
| Urea | 0.37 | 0.369 | 0.366 | 0.373 | 0.373 | 0.380 | 0.366 |
| Antioxidant | 0.29 | 0.291 | 0.289 | 0.294 | 0.294 | 0.300 | 0.289 |
| Total | 100 | 100 | 100 | 100 | 100 | 100 | 100 |

Lap Shear Strength Results in Megapascals (MPa)

| Cure Conditions | Ex. 7 | Ex. 8 | Ex. 9 | Ex. 10 | Ex. 11 | Ex. 12 | Ex. 13 |
|---|---|---|---|---|---|---|---|
| LSS-6111 Al; 140° C. | 0.32 | 0.64 | 0.84 | 0.76 | 0.86 | 0.84 | 0.46 |
| LSS-6111 Al; 135° C. | 0.28 | | | | | | |
| LSS-6111 Al; 130° C. | 0.28 | | | | | | |

### Lap Shear Strength Testing (LSS)

Compositions of Examples 6-12 were each tested on 6111 Aluminum as follows: 6111 Aluminum plates having a thickness of 0.8 mm and a size of 100 mm×25 mm were washed, an antirust oil was applied, and the composition was applied to one plate an area 25 mm×25 mm at a thickness of 3 mm; a second plate was applied to the composition, as shown in FIGS. 1 & 2 previously described. Each shear test piece was baked under cure conditions as shown in Table 4 maintained for 20 minutes. Separate shear test pieces of the composition of Example 6 were cured at three different temperatures as shown. Each shear test piece was allowed to cool to ambient temperature. Thereafter, using a general tensile tester, each shear test piece was subjected to force applied at a controlled rate until the bond broke and the maximum force recorded. The moving speed of the clamp was 50 mm/min. LSS results are given in MegaPascals.

The present invention can be utilized in all industrial fields which require adhesives and sealants that achieve full cure at oven temperatures of 130-150° C. with cure times of about 10-30 minutes, preferably up to 20 minutes and exhibit a small ratio of decrease in strength due to high temperature curing, meaning cure temperatures of 190-210° C. The composition according to the present invention can be particularly effectively utilized in the vehicle and equipment construction industries.

What is claimed is:

1. A thermally curable composition, comprising:
a component (a) comprising:
(a1) a solid rubber;
(a2) an olefinic double bond-containing polymer which is liquid or pasty at 22° C.;
(a3) a processing oil; and
(a4) a liquid polydiene different from (a1-a3);
and
a component (b) a vulcanizing system comprising two or more of:
(b1) quinone dioxime;
(b2) an organic peroxide and
(b3) a multifunctional coagent comprising a monomer, oligomer or polymer having a plurality of α,β-unsaturated carbonyl functional groups.

2. The thermally curable composition according to claim 1, further comprising a component (c) comprising:
(c1) a physical blowing agent in an amount of 0 to 3 wt. % based on the total weight of the composition;
(c2) a chemical blowing agent in an amount of 0 to 4.0 wt. % based on the total weight of the composition; and
(c3) a urea-based blowing agent accelerator in an amount of 0 to 1 wt. %.

3. The thermally curable composition according to claim 1, wherein the vulcanizing system (b) is:
(b2) the organic peroxide present in an amount of 0.2 to 2.0%, based on the total weight of the composition; and
(b3) the multifunctional coagent is present in an amount of 0.3 to 7 wt. %, based on the total weight of the composition.

4. The thermally curable composition according to claim 2, wherein the amount of (c1), (c2) and (c3) is 0 wt. % based on the total weight of the composition.

5. The thermally curable composition according to claim 1, wherein the olefinic double bond-containing polymer (a2) comprises a polybutadiene grafted with maleic anhydride and (a2) has a mass average molecular weight of between 10,000 and 750 Daltons.

6. The thermally curable composition according to claim 5, wherein the polybutadiene grafted with about maleic anhydride (a2) comprises 4 to 20 pbw maleic anhydride moieties.

7. The thermally curable composition according to claim 1, wherein (a3) the processing oil comprises paraffin oil in an amount of 5 wt. % to 30 wt. %, based on the total weight of the composition.

8. The thermally curable composition according to claim 1, wherein (a4) the liquid polydiene different from (a1-a3) is a polybutadiene polymer having mass average molecular weight of 1000-50,000 g/mol.

9 The thermally curable composition according to claim 1, wherein (b3) the multifunctional coagent comprising a monomer, oligomer or polymer having a plurality of α,β-unsaturated carbonyl functional groups includes at least one tri-functional (meth)acrylate.

10. The thermally curable composition according to claim 1, wherein:
(a1) the solid rubber is present in an amount of about 8 to 20 wt. % based on total weight of the composition;
(a2) the olefinic double bond-containing polymer which is liquid or pasty at 22° C., is present in an amount of about 5 to 15 wt. % based on the total weight of the composition;
(a3) the processing oil is present in an amount of about 5 to 30 wt. % based on the total weight of the composition;
(a4) the liquid polydiene, different from (a1)-(a3) present in an amount of about 3 to 20 wt. % based on the total weight of the composition;
(b1) the quinone dioxime is present in an amount of 0.1 to 5 wt. % based on the total weight of the composition;
(b2) the organic curing agent is an organic peroxide, present in an amount of 0.05 to 5.0%, based on the total weight of the composition; and
(b3) the multifunctional coagent is present in an amount of 0.1 to 10 wt. %, based on the total weight of the composition; and
the thermally curable composition further comprises as additional components:
calcium oxide present in an amount of 0.1-6 wt. %; and
filler present in a total amount of 10 to 50 wt. %;
all wt. % amounts based on the total weight of the composition; and wherein the components are selected such that the thermally curable composition has a viscosity such that said composition is pumpable with a pump at a temperature in a range of 15 to 60° C.

11. The thermally curable composition according to claim 1, further comprising a filler (d) in an amount of 10 wt. % to 45 wt. %, based on the total weight of the composition.

12. An article of manufacture comprising a component having a metal surface and adhering said metal surface to the article of manufacture is the composition according to claim 1, as-cured at a temperature in a range of 120 to 140° C. for a time in a range of 10 to 20 min. thereby forming an adhesive bond between the article and the component, wherein the article of manufacture is a component of a vehicle, apparatus, tool or aircraft.

13. An article of manufacture comprising: a metal surface and adhered to a selected region of said metal surface is the composition according to claim 1; and a component in contact with the selected region; wherein the composition was cured at a temperature in a range of 120 to 140° C. for a time in a range of 10 to 20 min. thereby forming an adhesive bond between the metal surface and the component wherein the article of manufacture is a component of a vehicle, apparatus, tool or aircraft.

14. The article of manufacture of claim 13, wherein the component comprises a body in white outer shell and the metal surface comprises structural materials, wherein the as-cured composition is present as an underlay disposed therebetween.

15. An article of manufacture comprising a metal surface and adhered to said metal surface is the composition according to claim 1, as-cured at a temperature in a range of 120 to 140° C. for a time in a range of 10 to 20 min. thereby sealing the metal surface wherein the article of manufacture is a component of a vehicle, apparatus, tool or aircraft.

16. The article of manufacture of claim 15, wherein the structural materials comprise one or more of a roof arch, a rocker panel, a security element and a strengthening element.

17. A process for applying an adhesive or sealant to a metal substrate having at least one aluminum metal surface, comprising steps of:
delivering the composition according to claim 1 at a temperature in a range of 15 to 60° C. to a point of application;
depositing the composition in a liquid or pasty state onto a selected region of a first aluminum metal surface of the substrate;
optionally bringing a second metal substrate into contact with the selected region bearing the composition; and
subsequently heating the composition at a temperature in a range of 130 to 220° C., for a time sufficient to thereby form a cured composition bonded to the aluminum metal surface;
wherein Lap Shear Strength bond strength of the composition cured at 220° C. is at least 30-90% of the bond strength of the composition cured at 130° C.

18. The process of claim 17, further comprising a step of thermal curing, and optional foaming, by heating the composition to a temperature in a range of 120-140° C. and maintaining said temperature range for a period of 10 to 60 minutes.

19. An article of manufacture made according to the process of claim 17.
